(19) United States
(12) Patent Application Publication
(10) Pub. No.: US 2002/0124371 A1
(43) Pub. Date: Sep. 12, 2002

(54) Anchor driver tool for power hammer apparatus

(76) Inventor: Robert A. Livingston, Schererville, NJ (US)

Correspondence Address: S. Michael Bender, P.O. Box 530399, St. Petersburg, FL, 33747, US

(21) Appl. No.: 10/053,360

(22) Filed: Jan. 17, 2002

Related U.S. Application Data
(60) Provisional application No. 60/263,717, filed on Jan. 25, 2001.

(51) Int. Cl. B25B 27/00

(52) U.S. Cl. 29/275; 29/278

(57) ABSTRACT

A driver tool is provided for a power hammer apparatus and is employed for setting an anchor, such as a bolt anchor, into a well that is in a material, such as concrete material. The driver tool includes a power-hammer-attachment end, a riser portion connected to the power-hammer-attachment end, and an anchor setting end connected to the riser portion. The power-hammer-attachment end, the riser portion, and the anchor setting end are arranged along a common longitudinal axis and can be formed as a unified integrated structure. The riser portion includes a hand grip area. A method is also provided for installing an anchor into material using a power hammer apparatus.

### CROSS-REFERENCE TO RELATED APPLICATION

This application claims priority based upon my copending Provisional Application Serial No. 60/263,717; filed Jan. 25, 2001.

### BACKGROUND OF THE INVENTION

1. Field of the Invention

The present invention relates generally to anchor driver devices, and, more particularly, to an anchor driver tool for especially adapted for connecting to a power hammer apparatus.

2. Description of the Prior Art

Anchors are often secured in wells in structural members. In turn, objects are secured to the anchors. The structural members can be comprised of a wide variety of materials, including concrete and wood, among others. A well-installed anchor in a structural member is a form of a fastener for objects, and throughout the years, a number of innovations have been developed relating to powered devices for installing fasteners in structural members. The following U.S. patents are representative of some of those innovations: U.S. Pat. Nos. 4,595,134, 5,220,123, 5,611,474, 5,651,489, and 5,657,919.

More specifically, all of U.S. Pat. Nos. 4,595,134, 5,220,123, 5,611,474, 5,651,489, and 5,657,919 relate to devices that are specifically designed to drive fasteners into structural members. None of these patents relates to a tool that can be easily attached to or detached from a power hammer apparatus. Power hammer apparatuses useful devices, and it would be desirable if even more utility can be derived from such a power hammer apparatus. In this respect, it would be desirable if an anchor driver tool were provided that can easily be attached to and detached from a power hammer apparatus.

Another common feature of U.S. Pat. Nos. 4,595,134, 5,220,123, 5,611,474, 5,651,489, and 5,657,919 is the use of a fastener driving member that slides within a guide member in the respective powered fastener driving apparatus. For purposes of simplicity, it would be desirable if an anchor driver tool were provided for a power hammer apparatus that does not include one member that slides within another member. In this respect, it would be desirable if an anchor driver tool were provided for a power hammer apparatus that does not include any moving parts.

There are a number of popular power hammer apparatuses on the market, and it would be desirable if an anchor driver tool were provided that can be readily used with a number of popular power hammer apparatuses on the market.

More specifically, Hilti manufactures a number of power hammer apparatuses, and it would be desirable if an anchor driver tool were provided that can be readily used with a Hilti power hammer apparatus.

Also, more specifically, Bosch manufactures a number of power hammer apparatuses, and it would be desirable if an anchor driver tool were provided that can be readily used with a Bosch power hammer apparatus.

Thus, while the foregoing body of prior art indicates it to be well known to use power hammer apparatuses for driving fasteners into structural members, the prior art described above does not teach or suggest an anchor driver tool for a power hammer apparatus which has the following combination of desirable features: (1) can easily be attached to and detached from a power hammer apparatus; (2) does not include one member that slides within another member; (3) can be readily used with a number of popular power hammer apparatuses on the market; (4) can be readily used with a Hilti power hammer apparatus; (5) can be readily used with a Bosch power hammer apparatus; (6) and does not include any moving parts. The foregoing desired characteristics are provided by the unique anchor driver tool for a power hammer apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a driver tool for a power hammer apparatus and is employed for setting an anchor, such as a bolt anchor, into a well that is in a material, such as concrete material. The driver tool includes a power-hammer-attachment end, a riser portion connected to the power-hammer-attachment end, and an anchor setting end connected to the riser portion. The power-hammer-attachment end, the riser portion, and the anchor setting end are arranged along a common longitudinal axis and can be formed as a unified integrated structure. The riser portion includes a hand grip area.

The anchor has an internal anchor diameter, and the anchor setting end has an external setting-end diameter. The internal anchor diameter is greater than the external setting-end diameter. The anchor has an internal anchor depth from anchor top to a top of a fully driven-in movable internal wedge spreader portion. The anchor setting end has a longitudinal setting-end length that is greater than or equal to the internal anchor depth.

In accordance with another aspect of the present invention, a method is provided for installing an anchor into a well in material, wherein the anchor includes a movable internal wedge spreader portion and bottom wedge portions that are to be spread apart by the movable internal wedge spreader portion. The anchor installation method includes the steps of: (a) inserting a non-deformed anchor into the well, (b) inserting an anchor setting end of a driver tool that is connected to a power hammer apparatus into the anchor, (c) activating the power hammer apparatus to cause the anchor setting end of the driver tool to drive the movable internal wedge spreader portion deeply into the anchor to spread apart the bottom wedge portions, thereby driving the bottom wedge portions into the wall of the well in the material, and (d) removing the anchor setting end of the driver tool from the anchor, leaving the anchor fixed inside the well in the material.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved anchor driver tool for a power hammer apparatus which has all of the advantages of the prior art and none of the disadvantages.

It is another object of the present invention to provide a new and improved anchor driver tool for a power hammer apparatus which may be easily and efficiently manufactured and marketed.

It is a further object of the present invention to provide a new and improved anchor driver tool for a power hammer apparatus which is of durable and reliable construction.

An even further object of the present invention is to provide a new and improved anchor driver tool for a power hammer apparatus which is susceptible of a low cost of manufacture with regard to both materials and labor, and which accordingly is then susceptible of low prices of sale to the consuming public, thereby making such anchor driver tool for a power hammer apparatus available to the buying public.

Still yet a further object of the present invention is to provide a new and improved anchor driver tool for a power hammer apparatus which can easily be attached to and detached from a power hammer apparatus.

Still another object of the present invention is to provide a new and improved anchor driver tool for a power hammer apparatus that does not include one member that slides within another member.

Yet another object of the present invention is to provide a new and improved anchor driver tool for a power hammer apparatus which can be readily used with a number of popular power hammer apparatuses on the market.

Even another object of the present invention is to provide a new and improved anchor driver tool for a power hammer apparatus that can be readily used with a Hilti power hammer apparatus.

Still a further object of the present invention is to provide a new and improved anchor driver tool for a power hammer apparatus which can be readily used with a Bosch power hammer apparatus.

Yet another object of the present invention is to provide a new and improved anchor driver tool for a power hammer apparatus that does not include any moving parts.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a perspective view showing a first embodiment of the anchor driver tool for a power hammer apparatus of the invention, wherein the anchor driver tool is designed for fitting a Hilti Model TE 72 power hammer apparatus, or equivalent thereof.

FIG. 2 is a top view of the embodiment of the anchor driver tool for a power hammer apparatus shown in FIG. 1 taken along line 2-2 of FIG. 1.

FIG. 3 is a bottom view of the embodiment of the anchor driver tool for a power hammer apparatus of FIG. 1 taken along line 3-3 thereof.

FIG. 4 is a perspective view showing a second embodiment of the anchor driver tool for a power hammer apparatus of the invention, wherein the anchor driver tool is designed for fitting a Bosch Model 11236VS power hammer apparatus, or equivalent thereof.

FIG. 5 is a top view of the embodiment of the anchor driver tool for a power hammer apparatus shown in FIG. 4 taken along line 5-5 of FIG. 4.

FIG. 6 is a bottom view of the embodiment of the anchor driver tool for a power hammer apparatus of FIG. 4 taken along line 6-6 thereof.

FIG. 7 is a side view of an anchor driver tool of the invention used with a power hammer apparatus for setting an anchor, shown in cross-section, in a cross-sectional view of a well that has been drilled into a concrete article.

FIG. 8 is cross-sectional view of the anchor installed in the concrete well, both of which are shown in FIG. 7.

### DESCRIPTION OF THE PREFERRED EMBODIMENT

With reference to the drawings, a new and improved anchor driver tool for a power hammer apparatus embodying the principles and concepts of the present invention will be described.

Turning to FIGS. 1-3, there is shown a first embodiment of the anchor driver tool for a power hammer apparatus of the invention generally designated by reference numeral 10. In the first embodiment, a driver tool 10 for a power hammer apparatus 12 is provided for setting an anchor 14 into a well 16, such as in concrete material 40. The driver tool 10 includes a power-hammer-attachment end 18, a riser portion 20 connected to the power-hammer-attachment end 18, and an anchor setting end 22 connected to the riser portion 20. The power-hammer-attachment end 18, the riser portion 20, and the anchor setting end 22 are arranged along a common longitudinal axis 24 and can be formed as a unified integrated structure. The riser portion 20 includes a hand grip area 26.

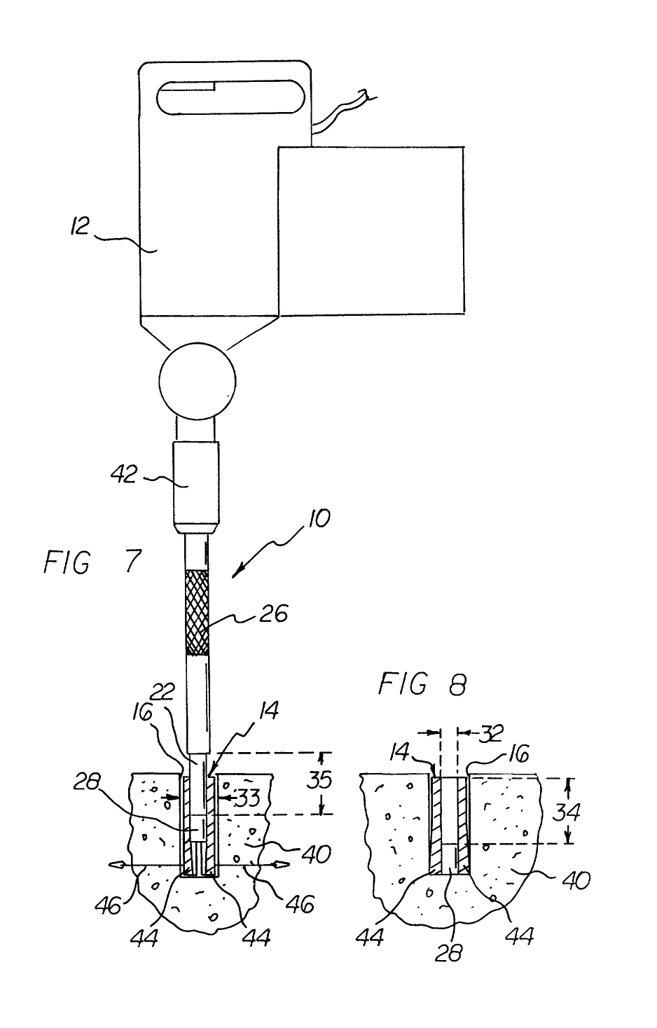

With special reference to FIGS. 7 and 8, the anchor 14 has an internal anchor diameter 32, and the anchor setting end 22 has an external setting-end diameter 33. The internal anchor diameter 32 is greater than the external setting-end diameter 33. The anchor 14 has an internal anchor depth 34 from anchor top to a top of a fully driven-in movable internal wedge spreader portion 28. The anchor setting end 22 has a longitudinal setting-end length 35 that is greater than or equal to the internal anchor depth 34.

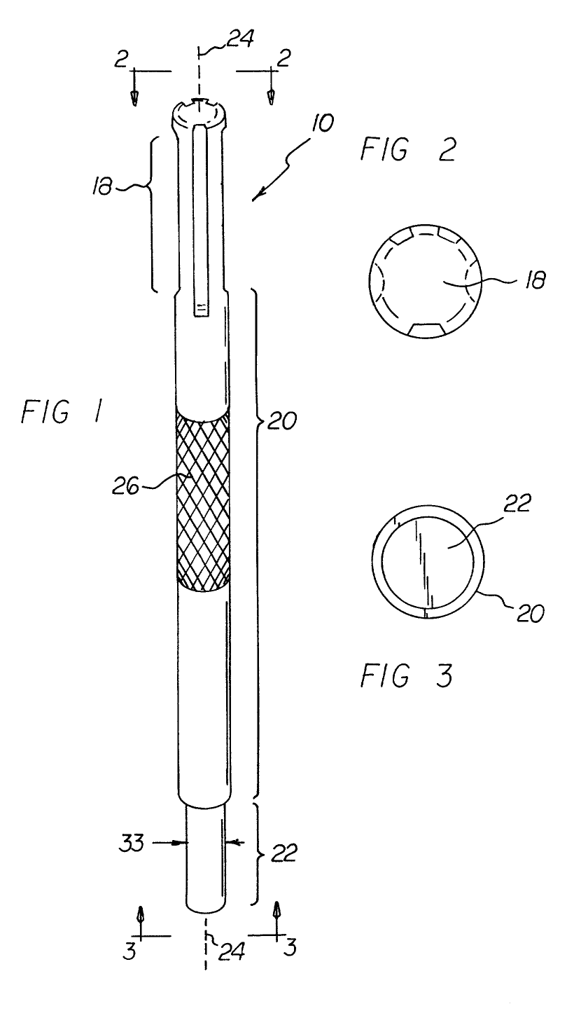

As shown in the embodiment of the invention in FIGS. 1 and 2, the power-hammer-attachment end 18 can be designed to be received by a Hilti Model TE 72 power hammer or equivalent thereof.

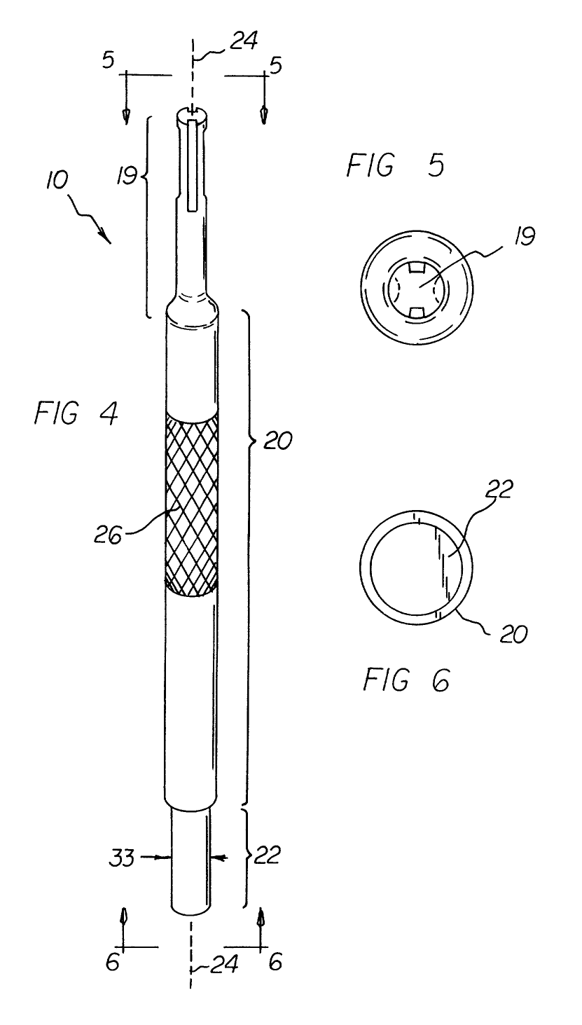

As shown in the embodiment of the invention in FIGS. 4 and 5, the power-hammer-attachment end 19 can be designed to be received by a Bosch Model 11236VS power hammer or equivalent thereof.

Use of either embodiment of the invention is shown in FIGS. 7 and 8. More specifically, a portion of concrete material 40 is selected. A well 16 is drilled in the concrete material 40 by using a drill bit (not shown) that is connected to the power hammer apparatus 12 by the chuck 42. The well 16 can be drilled by setting the power hammer apparatus 12 to a “drill and hammer” mode. After the well 16 has been drilled, the drill bit is removed, and the driver tool 10 of the invention is connected to the power hammer apparatus 12 using the chuck 42.

Then, a non-deformed anchor 14, shown in FIG. 7, is inserted into the well 16. The anchor 14 is a well known tubular anchor (which can be a Power's shell) for concrete and includes an internally threaded top tubular portion for receiving a complimentary threaded anchor bolt, bottom wedge portions 44 extending below the internally threaded top portion, and a movable internal wedge spreader portion 28 that is initially present in the top tubular portion but is later driven downward to spread out the bottom wedge portions 44.

After the non-deformed anchor 14 has been inserted into the well 16, the anchor setting end 22 of the driver tool 10 is inserted into the anchor 14, as shown in FIG. 7. The power hammer apparatus 12 is switched to the “hammer” mode, and the power hammer apparatus 12 causes the anchor setting end 22 to reciprocate up and down in the “hammer” mode. As the anchor setting end 22 reciprocates up and down, the anchor setting end 22 hammers down the movable internal wedge spreader portion 28 deeper into the anchor 14. With the power hammer apparatus 12 in the “hammer” mode, the anchor setting end 22 drives the movable internal wedge spreader portion 28 against the bottom wedge portions 44 of the anchor 14, causing the bottom wedge portions 44 to spread outward in the directions shown by arrows 46. This spreading action causes the bottom wedge portions 44 to dig into the walls of the well 16 in the concrete material 40 and to securely set the anchor 14 in the concrete material 40. Stated differently, the anchor 14 is firmly fixed or anchored in the well 16 in the concrete material 40. Then, the anchor setting end 22 of the driver tool 10 is removed from the anchor 14, as shown in FIG. 8. A bolt (not shown) can be screwed into the internally threaded top tubular portion of the anchor 14. In this way, the bolt is secured in the concrete material 40 by the securely set anchor 14. Moreover, any article attached to such an anchor-engaged bolt is also secured to the anchor 14 in the concrete material 40.

Because the external setting-end diameter 33 is less than the internal anchor diameter 32, the anchor setting end 22 easily moves up and down inside the anchor 14 as the anchor setting end 22 drives the movable internal wedge spreader portion 28 into deep contact with the bottom wedge portions 44. Because the longitudinal setting-end length 35 is greater than or equal to the internal anchor depth 34, the movable internal wedge spreader portion 28 is driven completely to the bottom of the bottom wedge portions 44 to assure a maximum spreading out movement of the bottom wedge portions 44. Such a maximum spreading out movement of the bottom wedge portions 44 provides a maximumly secure anchoring of the anchor 14 in the concrete material 40.

In accordance with another aspect of the present invention, a method is provided for installing an anchor 14 into a well in material, wherein the anchor 14 includes a movable internal wedge spreader portion 28 and bottom wedge portions 44 that are to be spread apart by the movable internal wedge spreader portion 28. The anchor installation method includes the steps of: (a) inserting a non-deformed anchor 14 into the well 16, (b) inserting an anchor setting end 22 of a driver tool 10 that is connected to a power hammer apparatus 12 into the anchor 14, (c) activating the power hammer apparatus 12 to cause the anchor setting end 22 of the driver tool 10 to drive the movable internal wedge spreader portion 28 deeply into the anchor 14 to spread apart the bottom wedge portions 44, thereby driving the bottom wedge portions 44 into the wall of the well in the material, and (d) removing the anchor setting end 22 of the driver tool 10 from the anchor 14, leaving the anchor 14 fixed inside the well 16 in the material.

The components of the anchor driver tool for a power hammer apparatus of the invention can be made from durable metal materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved anchor driver tool for a power hammer apparatus that is low in cost, relatively simple in design and operation, and which may advantageously be attached to and detached from a power hammer apparatus. With the invention, an anchor driver tool for a power hammer apparatus is provided which does not include one member that slides within another member. With the invention, an anchor driver tool for a power hammer apparatus is provided which can be readily used with a number of popular power hammer apparatuses on the market. With the invention, an anchor driver tool for a power hammer apparatus is provided which can be readily used with a Hilti power hammer apparatus. With the invention, an anchor driver tool for a power hammer apparatus is provided which can be readily used with a Bosch power hammer apparatus. With the invention, an anchor driver tool for a power hammer apparatus is provided which does not include any moving parts.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

What is claimed as being new and desired to be protected by Letters Patent of the United States is as follows:

1. A driver tool for a power hammer apparatus for setting an anchor into a well, comprising:
a power-hammer-attachment end,
a riser portion connected to said power-hammer-attachment end, and
an anchor setting end connected to said riser portion,
wherein said power-hammer-attachment end, said riser portion, and said anchor setting end are arranged along a common longitudinal axis.

2. The apparatus of claim 1 wherein said riser portion includes a hand grip area.

3. The apparatus of claim 1 wherein:
the anchor has an internal anchor diameter,
said anchor setting end has an external setting-end diameter, and
said internal anchor diameter is greater than said external setting-end diameter.

4. The apparatus of claim 1 wherein:
the anchor has an internal anchor depth from anchor top to a top of a fully driven-in movable internal wedge spreader portion, and
said anchor setting end has a longitudinal setting-end length that is greater than or equal to said internal anchor depth.

5. The method of installing an anchor into a well in material, wherein the anchor includes a movable internal wedge spreader portion and bottom wedge portions that are to be spread apart by the movable internal wedge spreader portion, comprising the steps of:
inserting a non-deformed anchor into the well,
inserting an anchor setting end of a driver tool that is connected to a power hammer apparatus into the anchor,
activating the power hammer apparatus to cause the anchor setting end of the driver tool to drive the movable internal wedge spreader portion deeply into the anchor to spread apart the bottom wedge portions, thereby driving the bottom wedge portions into the wall of the well in the material, and
removing the anchor setting end of the driver tool from the anchor, leaving the anchor fixed inside the well in the material.
